(19) United States
(12) Patent Application Publication
(10) Pub. No.: US 2014/0318250 A1
(43) Pub. Date: Oct. 30, 2014

(54) METHOD FOR INSPECTING WELD PENETRATION DEPTH

(71) Applicants: Toshinobu Arai, Nagoya-shi (JP); Keisuke Uchida, Nagoya-shi (JP); Shingo Iwatani, Nagoya-shi (JP); Takahiro Kitamura, Anjo-shi (JP); Masami Fukushima, Toyota-shi (JP); Shotaro Kato, Susono-shi (JP); Yoshikatsu Goda, Toyota-shi (JP); Shuhei Yamaguchi, Kariya-shi (JP)

(72) Inventors: Toshinobu Arai, Nagoya-shi (JP); Keisuke Uchida, Nagoya-shi (JP); Shingo Iwatani, Nagoya-shi (JP); Takahiro Kitamura, Anjo-shi (JP); Masami Fukushima, Toyota-shi (JP); Shotaro Kato, Susono-shi (JP); Yoshikatsu Goda, Toyota-shi (JP); Shuhei Yamaguchi, Kariya-shi (JP)

(73) Assignee: TOYOTA JIDOSHA KABUSHIKI KAISHA, Toyota-shi (JP)

(21) Appl. No.: 14/360,438

(22) PCT Filed: Nov. 24, 2011
(86) PCT No.: PCT/JP2011/077083

§ 371 Date: Jun. 23, 2014

(51) Int. Cl. B23K 31/12; G01B 15/02

(52) U.S. Cl. CPC B23K 31/125; G01B 15/02
USPC 73/588

(57) ABSTRACT

In a butt-welded joint structure in which the entire peripheral edge or both end sides of the abutting surface are welded, first and second cutouts for determining insufficient penetration and determining excessive penetration are formed. After butt welding, ultrasound is beamed onto each of the first and second cutouts of the joint structure and the reflected wave is measured. The acceptability of the weld penetration depth is thus determined on the basis of both of the reflected waves. This determination is performed on the entire peripheral edge portion or both end side portions of the butted face between the welded materials, and the acceptability of the weld penetration depth of the corresponding portions is inspected.

### TECHNICAL FIELD

The present invention relates to methods for inspecting the weld penetration depth in a welded portion welded by laser welding etc.

### BACKGROUND ART

Conventionally, a method described in Patent Document 1 is known as a method for inspecting the weld penetration depth in a welded portion. For example, for the welding condition of a welded portion of a plate and a tube, a probe is inserted in the tube, and ultrasonic waves are emitted to a part where the tip end of the welded portion is expected to be located, and whether the welded portion having a required penetration depth has been formed or not is determined based on reflected waves of the ultrasonic waves.

A but welding joint described in Patent Document 2 is also known as a butt welding joint that makes it possible to easily and reliably determining a weld penetration defect. In this method, in a butt welding joint that is used to weld workpieces from one side of the abutting position of the workpieces, an edge portion that faces the workpiece located on the opposite side from the side from which welding is performed is chamfered, and a penetration defect is determined based on the magnitude of reflection echoes of ultrasonic waves emitted toward the welded portion.

### PRIOR ART DOCUMENTS

### Patent Documents

Patent Document 1: Japanese Patent Application Publication No. 2001-289826 (JP 2001-289826 A)

Patent Document 2: Japanese Patent Application Publication No. H06-167479 (JP H06-167479 A)

### SUMMARY OF THE INVENTION

### Problem to be Solved by the Invention

The prior art described in Patent Documents 1 and 2 can determine an insufficient weld penetration depth, but cannot determine an excessive weld penetration depth. Not being able to determine an excessive penetration depth doesn't cause a big problem in terms of welding strength if only one end of the abutting surface between the workpieces is to be welded. However, like an insufficient penetration depth, an excessive penetration depth (an excessive penetration depth in a part of the circumference in the case of welding the entire peripheral portions) causes a problem in terms of welding strength if both end portions or the entire peripheral end portion of the abutting surface between the workpieces are to be welded.

In such welding, not only the insufficient penetration depth but also the excessive penetration depth result in uneven welding strength in both ends or the entire peripheral end of the abutting surface between the workpieces, This causes distortion in the workpieces or the welded portion, reducing strength, durability, etc. of the welded portion not only in a part having an insufficient penetration depth but also in a part having an adequate penetration depth.

It is therefore necessary to reliably determine not only the insufficient penetration depth but also the excessive penetration depth in the case of welding both end portions or the entire peripheral end portion of the abutting surface between the workpieces, and improvement has been desired in this point.

The present invention was developed in view of such a demand, and it is an object of the present invention to provide a method for inspecting a weld penetration depth in which not only an insufficient weld penetration depth but also an excessive weld penetration depth can be reliably determined and the same penetration depth can he obtained in the entire welded portion in the case of welding both end portions or the entire peripheral end portion of abutting surfaces of workpieces.

### Means for Solving the Problem

A method for inspecting a weld penetration depth according to the present invention is characterized by, after performing butt welding of both end portions or an entire peripheral end portion of abutting surface between workpieces including a joint structure that includes, in each of the both end portions or the entire peripheral end portion of the abutting surface between the workpieces, a cutout that reflects ultrasonic waves when a weld has not been penetrated therein, the cutout including a first cutout that is used to determine insufficient weld penetration and a second cutout that is used to determine excessive weld penetration, performing, on the both end portions or the entire peripheral end portion of the abutting surface between the workpieces, a first step of emitting ultrasonic waves toward the first cutout or the second cutout of the joint structure and measuring reflected waves thereof, a second step of emitting the ultrasonic waves toward the second cutout or the first cutout of the joint structure and measuring reflected waves thereof, and a third step of determining whether the weld penetration depth is satisfactory or not based on the reflected waves measured in the first step and the second step, and thus inspecting whether the weld penetration depth in the both end portions or the entire peripheral end portion is satisfactory or not.

### EFFECTS OF THE INVENTION

In the method for inspecting the weld penetration depth according to the present invention, the joint structure for butt welding is provided with. the first cutout that is used to determine insufficient weld penetration and the second cutout that is used to determine excessive weld penetration in order to determine whether the weld penetration depth is adequate or not. Accordingly, whether the weld penetration depth is satisfactory or not can be reliably determined. Moreover, whether the weld penetration depth is satisfactory or not is determined in both end portions or the entire peripheral end portion of the abutting surface between. the workpieces, and the same penetration depth can be obtained in the entire welded portion. This can prevent distortion in the welded portion and a portion around the welded portion, and thus can improve strength, durability, etc. of the welded portion.

Moreover, whether the weld penetration depth is satisfactory or not can be easily determined. and inspected by using only the measurement technique using the joint structure having two different cutouts and ultrasonic waves. The present invention is thus highly advantageous when applied to total inspection of welded portions in mass production lines.

### BRIEF DESCRIPTION OF THE DRAWINGS

FIG. 1 is a side view showing a joint structure to which a method of the present invention is applied.

FIG. 2 is an enlarged view of a portion surrounded by broken line in FIG. 1 leg length portion).

FIG. 3 is an enlarged view of an upper end portion of the joint structure in FIG. 1.

FIG. 4 is an illustration of inspection of the weld penetration depth by a method for inspecting a weld penetration depth according to an embodiment of the present invention.

FIG. 5 is a view showing how ultrasonic waves are transmitted and received in the case where the inspection result of the inspection method is an adequate penetration depth (adequate leg, length).

FIG. 6 is a view showing how ultrasonic waves are transmitted and received in the case where the inspection result is an insufficient penetration depth (insufficient leg length).

FIG. 7 is a view showing how ultrasonic waves are transmitted and received in the case where the inspection result is an excessive penetration depth (excessive leg length).

FIG. 8 shows the state of received waves of the ultrasonic waves [FIG . 8A] and the wavelength thereof [FIG. 8B] in the case where the inspection result is an adequate penetration depth.

FIG. 9 shows the state of received waves of the ultrasonic waves [FIG. 9A] and the wavelength thereof [FIG. 9B] in the case where the inspection result is an insufficient penetration depth.

FIG. 10 is a sectional view showing another joint structure to which the method of the present invention is applied.

### MODES FOR CARRYING OUT THE INVENTION

An embodiment of the present invention will be described with reference to the accompanying drawings. The same reference characters denote the same or equivalent portions throughout the figures.

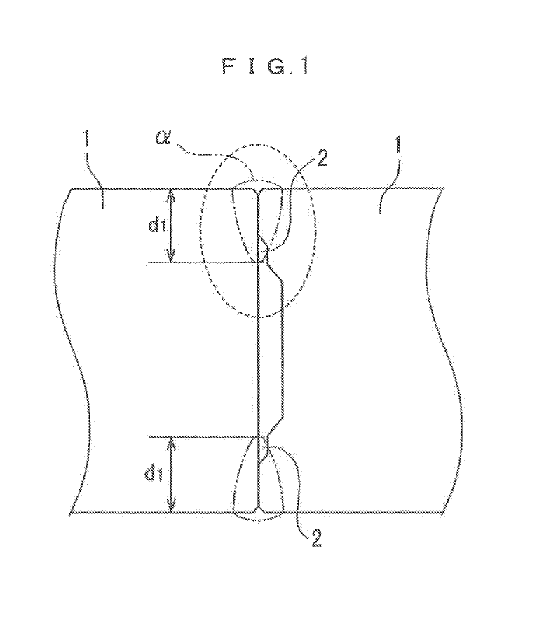

FIG. 1 is a side view showing a joint structure (abutting surface portions of workpieces to be welded together) to which a method of the present invention is applied.

As shown in this figure, the joint structure to which the method of the present invention is applied is a joint structure of butt welding in which a pair of workpieces 1, 1 are bonded together by welding the upper and lower end portions of the abutting surface between the pair of workpieces 1, 1 with the same leg length d1.

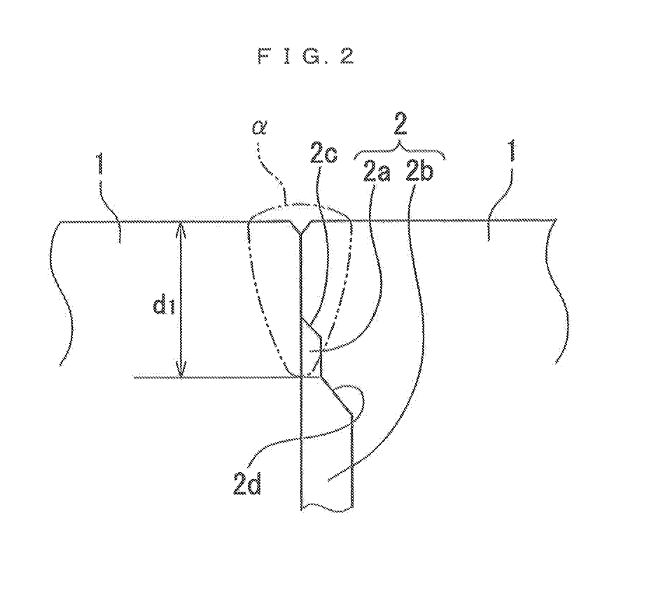

This joint structure includes, in each of the upper and lower end portions of the abutting surface between the workpieces 1, 1, a cutout 2 that reflects ultrasonic waves for weld penetration inspection if the weld has not penetrated therein. In this example, the joint structure includes the cutouts 2 in one of the workpieces 1, 1 which is located on the right side in the figure. One of these cutouts 2 which is formed in the upper end portion is shown in an enlarged view in FIG. 2.

A portion α surrounded by two-dot chain line in FIGS. 1 and 2 shows a welded portion (portion where the weld has penetrated) in the case where welding has been properly performed.

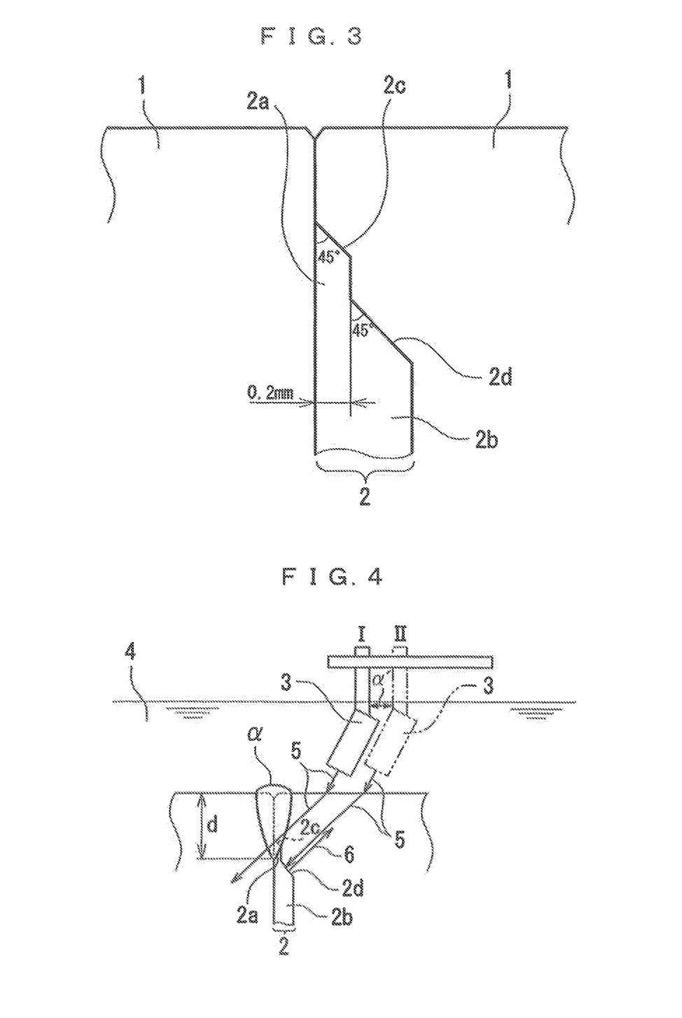

The cutout 2 will be described in detail with reference to FIG. 3. Although FIG. 3 shows the cutout 2 in the upper end portion of the abutting surface between the workpieces 1, 1, the cutout 2 in the lower end portion of the abutting surface is formed similarly (see FIG. 1).

That is, each cutout 2 in the upper and lower end portions of the abutting surface between the workpieces 1, 1 includes a first cutout 2a that is used to determine insufficient weld penetration, and a second cutout 2b that is used to determine excessive weld penetration.

In this case, the first cutout 2a is formed so as to extend along, the leg length d1 (see FIGS. 1 and 2) of the welded portion a having a desired length that is set from the upper end toward the lower end of the abutting surface between the workpieces 1, 1 and to include a tip end position portion of the leg length d1. In the present embodiment, the first cutout 2a is formed so that substantially the entire length of the first cutout 2a overlaps the tip end position portion of the leg length d1.

The second cutout 2b is formed so as to be continuous (communicate) with the first cutout 2a and to have a predetermined length toward the other end of the abutting surface between the workpieces 1, .

The first cutout 2a and the second cutout 2b have tilted surfaces 2c, 2d that reflect ultrasonic waves emitted toward. each cutout 2a, 2b substantially in the opposite direction to the emission direction in the case where the weld has not penetrated into the cutouts 2a, 2b.

That is, the cutout 2 is shaped so as to have two steps in the direction away from the abutting surface between the workpieces 1, 1 (the rightward direction in the figure) and two steps in the direction from the upper end toward the lower end of the abutting surface, and is formed so as to include the first cutout 2a and the second cutout 2b in this two-step shape. The tilted surfaces 2c, 2d are respectively formed at the starting ends of the first and second cutouts 2a, 2b which are located closer to the upper surface of the workpiece

In the example shown in FIG. 3, the interval between the abutting surface of the workpieces 1, 1 and the surface of the first cutout 2a which opposes the abutting surface is set to 0.2 mm. This value “0.2 mm” is set as a minimum interval value that minimizes penetration into this interval in the case where the weld penetrates into the first cutout 2a, and that is enough for effective formation of an air layer, described below, in the case where the weld does not penetrate into the first cutout 2a.

The angle (interior angle) of each of the tilted surfaces 2c, 2d of the first and second. cutouts 2a, 2h with the abutting surface of the workpieces 1, 1 is set to 45°. This angle is set to 45° for reasons such as reflecting ultrasonic waves, emitted from a first position I and a second position II described below toward the cutouts 2a, 2b, substantially in the opposite direction to the emission direction in the case where the weld has not penetrated into the first cutout 2a and the second cutout 2b.

A first cutout 2a and a second cutout 2h which are similar to those described above are formed in the lower end portion of the abutting surface between the workpieces 1, 1. The first cutout 2a and the second. cutout 2b in the lower end portion are formed symmetrically with the cutouts 2a, 2b in the upper end portion with respect to a line horizontally crossing the center of the workpieces in the workpiece thickness direction (vertical direction in the figure). Namely, the first cutout 2a and the second cutout 2b in the lower end portion are formed similarly to the cutouts 2a, 2b in the upper pend portion in the position from the abutting surface between the workpieces 1, 1, dimensions, shape, etc.

The joint structure to which the method of the present invention is applied as described above is preferably configured to determine or inspect by using ultrasonic waves whether the weld penetration depth is satisfactory or not.

A method for inspecting the weld penetration depth according to the present embodiment will he described below with reference to FIGS. 4 to 9.

First, after butt welding of the upper and lower end portions of the abutting surface between the workpieces 1, 1 including the joint structure configured as shown in FIGS. 1 to 3, the workpieces 1, 1 and an ultrasonic probe 3 are immersed in water 4 as shown in FIG. 4. The workpieces 1, 1 and the ultrasonic probe 3 are immersed in water in order for ultrasonic waves (transmitted waves) 5 from the ultrasonic probe 3 to be more easily incident on the workpiece 1, 1, and in order for reflected waves (received waves) 6 from the workpieces 1, Ito be more easily incident on the ultrasonic probe 3.

The workpieces 1, 1 are fixed and placed in the water 4 shown in FIG. 4. The ultrasonic probe 3 is placed. so as to be able to move between the first position I shown by solid line and the second position II shown by two-dot chain line (see two-headed arrow “α′”) so that the ultrasonic probe 3 can emit ultrasonic waves 5 at least toward the tilted surface 2c of the first cutout 2a and the tilted surface 2d of the second cutout 2b in the joint structure.

The ultrasonic probe 3 is placed with the central axis of the ultrasonic waves being tilted at a predetermined angle with respect to the surfaces of the workpieces 1, 1, namely the upper surfaces thereof, so that the emitted. ultrasonic waves 5 are incident substantially at right angles on the tilted surfaces 2c, 2d of the first and second cutouts 2a, 2b.

In the example shown in FIG. 4, with the workpieces 1, 1 and the ultrasonic probe 3 being placed in the water 4 as described above, the ultrasonic probe 3 is first moved to the first position I shown by solid line to emit the ultrasonic waves 5 toward the tilted surface 2c of the first cutout 2a of the joint structure, and reflected. waves 6 of the ultrasonic waves 5 are measured (first step).

Next, the ultrasonic probe 3 is moved to the second position II shown by two-dot chain line in FIG. 4 to emit the ultrasonic waves 5 toward the tilted surface 2d of the second cutout 2b of the joint structure, and reflected waves 6 of the ultrasonic waves 5 are measured (second step).

Next, it is determined whether the weld penetration depth is satisfactory or not (whether a leg length d of the welded portion a is adequate or not) based on the reflected waves 6 from the tilted surface 2c of the first cutout 2a and the tilted surface 2d of the second cutout 2b (third step).

The determination of whether the weld penetration depth is satisfactory or not is thus completed for the upper end portion of the abutting surface between the workpieces 1, 1. After this determination is completed, the first to third steps are performed on the lower end portion of the abutting surface between the workpieces 1, 1. That is, it is determined whether the weld penetration depth in the lower end portion of the abutting surface between the workpieces 1, 1 is satisfactory or not, and inspection of whether the weld penetration depth is satisfactory or not (inspection of the weld penetration depth) is completed. The first and second steps may be performed in reverse order.

Whether the weld penetration depth is satisfactory or not is determined based on the reflected waves 6 in the following manner.

Ultrasonic waves are greatly reflected in a part of their travelling path where acoustic impedance changes significantly, such as in a part where there is an air layer.

Accordingly, if the weld has not penetrated into the cutout 2( 2a, 2b) forming the air layer, the ultrasonic waves are greatly reflected. at the position of this cutout 2. If the weld has penetrated into the cutout 2, there is no air layer in the cutout 2, and therefore the ultrasonic waves are hardly reflected at the position of the cutout 2 and are transmitted therethrough.

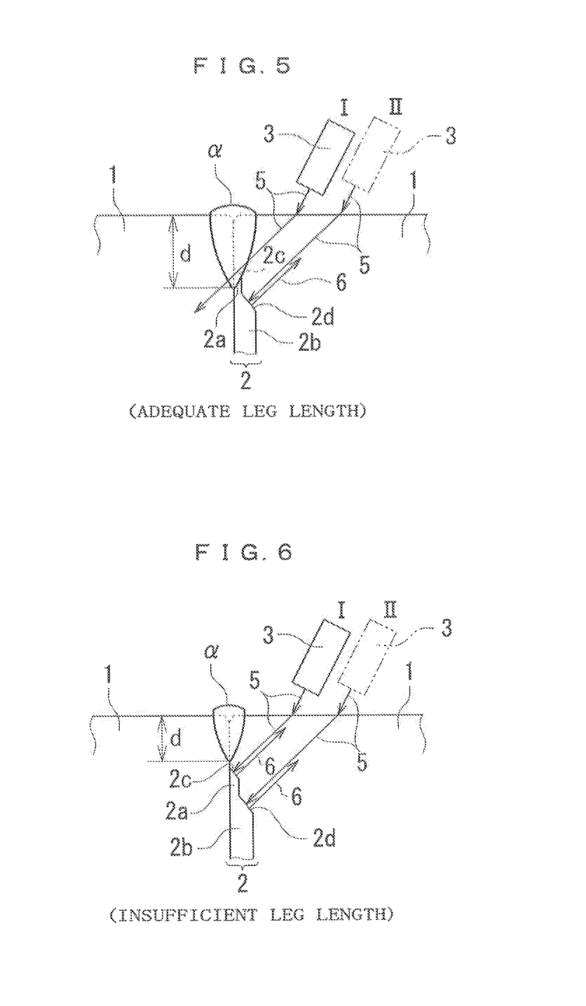

As shown in FIGS. 4 and 5, in the case where the penetration depth in the welded portion α is adequate (adequate leg length), the ultrasonic waves 5 emitted from the ultrasonic probe 3 at the first position I toward the tilted surface 2c of the first cutout 2a are transmitted through the welded portion α without being reflected by the tilted surface 2c. However, the ultrasonic waves 5 emitted from the ultrasonic probe 3 at the second position II toward the tilted surface 2d of the second cutout 2h are greatly reflected by the tilted surface 2d, and strong reflected waves 6 are detected by the ultrasonic probe 3.

As shown in FIG. 6, in the case where the penetration depth in the welded portion a is not sufficient (insufficient leg length), the ultrasonic waves 5 emitted from the ultrasonic probe 3 at the first position I toward the tilted surface 2c of the first cutout 2a are greatly reflected by the tilted surface 2c, and strong reflected waves 6 are detected by the ultrasonic probe 3. The ultrasonic waves 5 emitted from the ultrasonic probe 3 at the second position H toward the tilted surface 2d of the second cutout 2b are also greatly reflected by the tilted. surface, namely the tilted surface 2d, and strong reflected waves are detected by the ultrasonic probe 3.

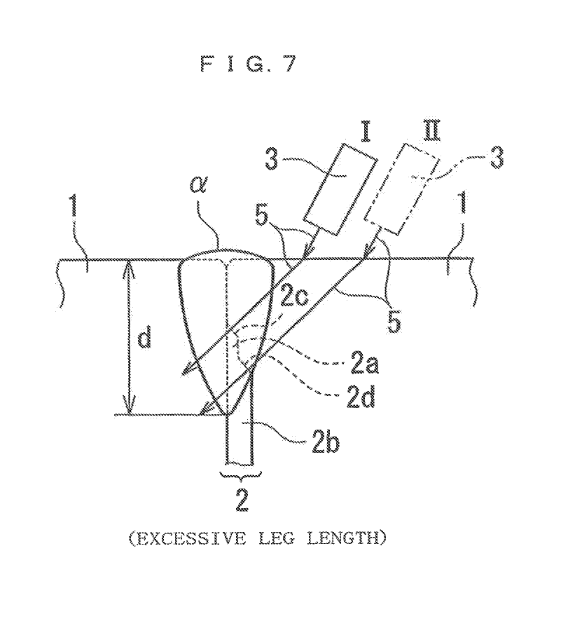

As shown in FIG. 7, in the case Where the penetration depth in the welded portion a is too large (excessive leg length), the ultrasonic waves 5 emitted from the ultrasonic probe 3 at the first position I toward the tilted surface 2c of the first cutout 2a are transmitted through the welded portion a without being reflected by the tilted surface 2c. The ultrasonic waves 5 emitted from the ultrasonic probe 3 at the second position H toward the tilted surface 2d of the second cutout 2b are also transmitted through the welded. portion a without being reflected by the tilted surface, namely the tilted surface 2d.

In this example, it is defined that there are no reflected waves if no reflected waves 6 are detected or only weak reflected waves 6 are detected by the ultrasonic probe 3, and it is defined that there are reflected waves if strong reflected waves 6 are detected by the ultrasonic probe 3. In this case, if there are no reflected waves when the ultrasonic roes 5 are emitted from the first position I and if there are reflected waves when the ultrasonic waves 5 are emitted from the second position II, it is determined that the leg length is adequate, namely it is determined that the weld penetration depth is satisfactory.

If there are reflected waves when the ultrasonic waves 5 are emitted from the first position I and the second position II, it is determined that the leg length is insufficient (the weld penetration depth is not satisfactory).

Moreover, if it is detected that there are no reflected waves When the ultrasonic waves 5 are emitted from the first position I and the second position II, it is determined that the leg length is excessive (the weld penetration depth is not satisfactory).

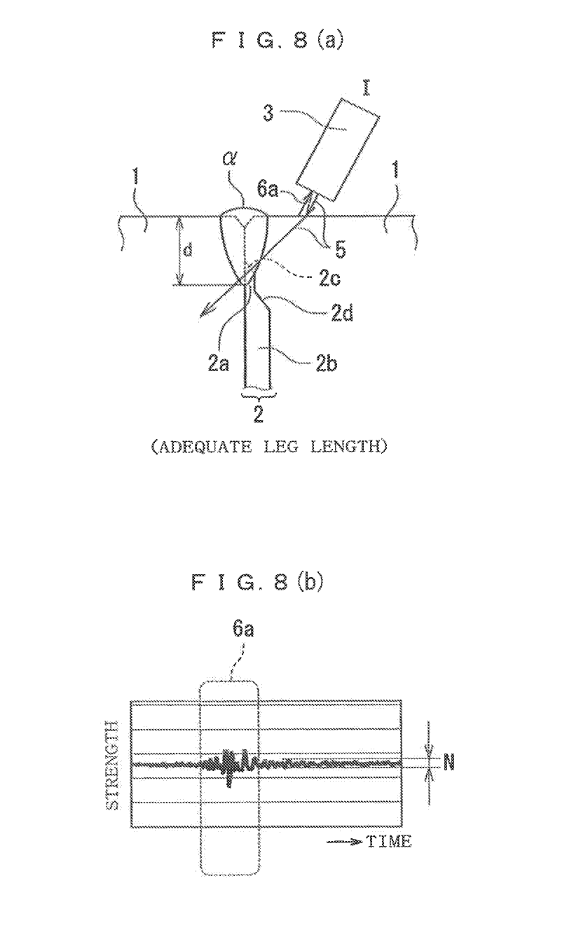

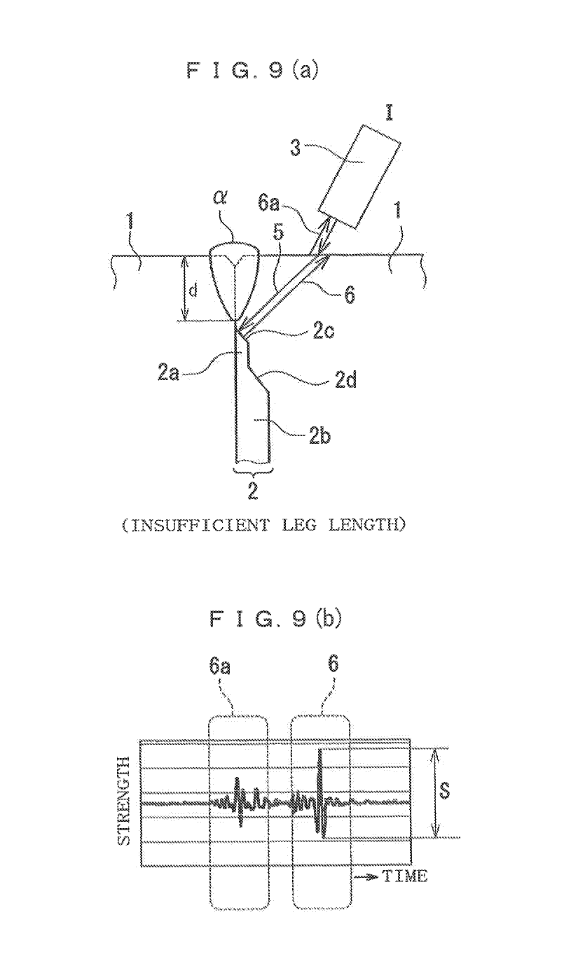

FIGS. 8 and 9 show by way of example the relation between the state of the received waves of the ultrasonic waves and the waveform thereof.

FIG. 8 shows the state of the received waves of the ultrasonic waves [FIG. 8A] and the wavelength thereof [FIG. 8B] in the case where it is determined that the leg length is adequate. FIG. 9 shows the state of the received waves of the Ultrasonic waves [FIG. 9A] and the wavelength thereof [FIG. 9B] in the case here it is determined that the I length is insufficient. In both figures, reference character 6a represents reflected waves from the upper surface of the workpiece 1.

As shown in FIG. 8A, in the case where it is determined that the leg length is adequate, the ultrasonic waves 5 emitted from the ultrasonic probe 3 at the first position I toward the tilted surface 2c of the first cutout 2a are transmitted through the welded portion u. without being reflected by the tilted surface 2c. Accordingly, as shown in FIG. 8B, the reflected waves 6a from the upper surface of the workpiece 1 appear in the waveform of the received waves. However, no reflected waves from the tilted surface 2c appear in the waveform of the received waves, and noise N having low signal strength merely appears therein. Although not shown in the figures, the ultrasonic waves 5 are reflected by the tilted surface 2d of the second cutout 2b, and the reflected waves having high signal strength from the tilted surface 2d appear in the waveform of the received waves subsequently to the reflected waves 6a from the upper surface of the workpiece and the noise N having low signal strength.

On the other hand, as shown in FIG. 9A, in the case where it is determined that the leg length is insufficient, the ultrasonic waves 5 emitted from the ultrasonic probe 3 at the first position 1 toward the tilted surface 2c, of the first cutout 2a are greatly reflected by the tilted surface 2c. Accordingly, as shown in FIG. 9B, reflected waves 6 having high signal strength S from the tilted surface 2c appear in the waveform of the received waves subsequently to the reflected waves 6a from the upper surface of the workpiece 1. The determination that the length is insufficient can be made only from the appearance of the reflected waves 6 from the tilted surface 2c. However, in order to make an accurate determination, it may be verified that reflected waves 6 having high signal strength S from the tilted surface 2d of the second cutout 2b also appear in the waveform of the received waves.

In the case where it is determined that the leg length is excessive, the reflected waves 6a from the upper surface of the workpiece I appears in the waveform of the received waves, However, no reflected waves 6 from the tilted surface 2c and the tilted surface 2d appear therein, and noise N having low signal strength appears subsequently to the reflected waves 6a.

According to the present embodiment, in the, joint structure of the butt welding, the first cutout that is used to determine insufficient weld penetration, and the second cutout that is used to determine excessive weld penetration are provided to determine whether the leg length of the welded portion is adequate or not. Accordingly, not only the determination that the leg length is insufficient but also the determination that the leg length is excessive can be reliably made. That is, whether the weld penetration depth is satisfactory or not can be reliably determined.

Moreover, such determination of whether the leg length of the welded portion is adequate or not (determination of whether the weld penetration depth is satisfactory or not) is made for each of the both end portions of the abutting surface between the workpieces. If it is determined that the leg lengths in both ends of the abutting surface between the workpieces are adequate, it shows that the leg lengths of the welded portions in both ends are substantially the same. This also means not only that the strengths of the individual weld portions are adequate, but also that both end portions of the abutting surface between the workpieces are balanced in terms of the welding strength, Accordingly, distortion can be prevented from being caused in the welded portions and the portions around the welded portions. Thus, strength, durability, etc. of the welded portions can be improved. and products with an unsatisfactory weld penetration depth can be reliably removed.

Whether the weld penetration depth is satisfactory or not can thus be determined and inspected based on the determination of whether the leg length is adequate or not by using only the measurement technique using the joint structure having two different cutouts and ultrasonic waves. Since whether the weld penetration depth is satisfactory or not can be easily determined and inspected, the present invention is highly advantageous particularly when applied to total inspection of the welded portions in mass production lines.

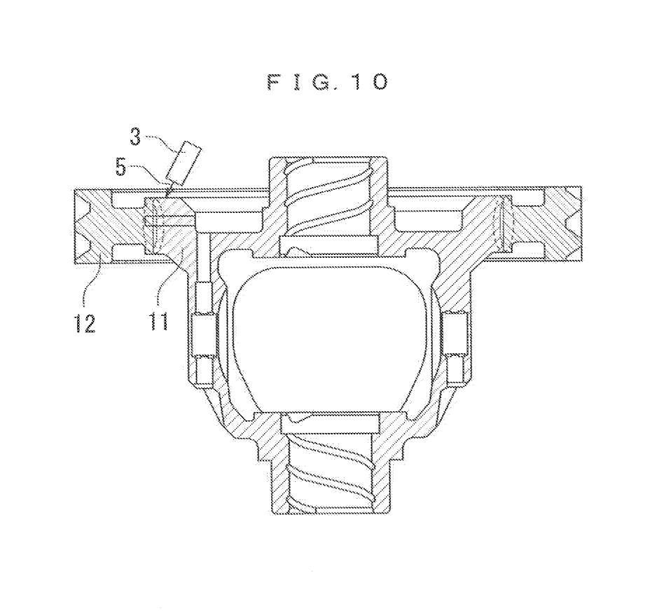

The above embodiment is described with respect to the example of the joint structure applied to the method of the present invention, in which the upper and lower end portions of the abutting surface between the pair of workpieces are bonded together to the same leg length by butt welding. However, it should be understood that the present invention is not limited to this. For example, as shown in FIG. 10, the present invention is also applicable to a joint structure in which the entire peripheral end portion (the peripheral end portion along the entire circumference) of the abutting surface between a differential case 11 and a ring gear 12 of an automobile are bonded to the same leg length by butt welding to bond the differential case 11 and the ring gear 12.

### DESCRIPTION OF THE REFERENCE NUMERALS

1: workpiece, 2: cutout, 2a: first cutout, 2b: second cutout, 2c: tilted surface of first cutout, 2d: tilted surface of second cutout, 5: emitted ultrasonic waves (transmitted waves), 6, 6a: reflected waves (received waves), d, d1: leg length, α: welded portion (weld penetration portion)

1. A method for inspecting a weld penetration depth, characterized in that
after performing butt welding of both end portions or an entire peripheral end portion of abutting surface between workpieces including a joint structure that includes, in each of the both end portions or the entire peripheral end portion of the abutting surface between the workpieces, a cutout that reflects ultrasonic waves in a case where a weld has not penetrated therein, the cutout including a first cutout that is used to determine insufficient weld penetration and a second cutout that is used to determine excessive weld penetration,
performing, on the both end portions or the entire peripheral end portion of the abutting surface between the workpieces, a first step of emitting ultrasonic waves toward the first cutout or the second cutout of the joint structure and measuring reflected waves thereof, a second step of emitting the ultrasonic waves toward the second cutout or the first cutout of the joint structure and measuring reflected waves thereof, and a third step of determining whether the weld penetration depth is satisfactory or not based on the reflected waves measured in the first step and the second step, and thus inspecting whether the weld penetration depth in the both end portions or the entire peripheral end portion is satisfactory or not.

2. The method for inspecting the weld penetration depth according to claim 1, characterized in that
in the joint structure, the first cutout is formed so as to extend along a leg length of a welded portion having a desired length that is set from one end toward the other end of the abutting surface between the workpieces and to include a tip end position portion of the leg length,
the second cutout is formed so as to be continuous with the first cutout and to have a predetermined length toward the other end of the abutting surface between the workpieces,
each of the first cutout and the second cutout has a tilted surface that reflects the Ultrasonic waves emitted toward that cutout in an opposite direction to the emission direction in a case where the weld has not penetrated into that cutout, and
a first cutout and a second cutout, which are similar to the first and second cutouts including the tilted surface, are formed so as to extend from the other end toward the one end of the abutting surface between the workpieces symmetrically with respect to a line crossing a center of the workpieces in a workpiece thickness direction.
